(19) United States
(12) Patent Application Publication
(10) Pub. No.: US 2024/0174446 A1
(43) Pub. Date: May 30, 2024

(54) MANAGING A WAREHOUSE HAVING ROBOTS OF DIFFERENT TYPES

(71) Applicant: Caja Elastic Dynamic Solutions Ltd, Binyamina (IL)

(72) Inventors: Guy GLASS, Binyamina (IL); Nir ROZEN, Avtalion (IL); Yaroslav GOLDIN, Bahan (IL); Henri GARIH, Binyamina (IL)

(21) Appl. No.: 18/282,918

(22) PCT Filed: Mar. 23, 2022
(86) PCT No.: PCT/IB2022/052664

§ 371 Date: Sep. 19, 2023

Related U.S. Application Data
(60) Provisional application No. 63/164,566, filed on Mar. 23, 2021.
(60) Provisional application No. 63/164,574, filed on Mar. 23, 2021.

(51) Int. Cl. B65G 1/137; B65G 1/04

(52) U.S. Cl. CPC B65G 1/1375; B65G 1/0492

(57) ABSTRACT

A method for responding to managing one or more warehouses, the method including obtaining information about multiple tasks completion agents (TCAs) of the one or more warehouses, wherein a TCA is configured to execute a task related to fulfillments of an order to obtain an item stored in the one or more warehouses, wherein the TCAs may include robots of different types that differ from each other by one or more task related properties; receiving multiple orders to obtain multiple items stored in the one or more warehouses; and scheduling an execution of tasks related to the provision of the multiple items. Scheduling includes allocating at least some of the multiple TCAs to execute tasks related to the provision of the multiple items.

### CROSS REFERENCE TO RELATED APPLICATIONS

This application is a national phase filing under 35 U.S.C. § 371 of and claims priority to PCT Patent Application No. PCT/IB2022/052664, filed on Mar. 23, 2022, which claims priority benefit under 35. U.S.C. § 119 of U.S. Patent Application No. 63/164,566 and 63/164,574, filed on Mar. 23, 2021, the contents of each of which are hereby incorporated in their entireties by reference.

### BACKGROUND

Order fulfillment of orders placed over the Internet must take place within a relatively short period of time in order to be commercially competitive. The same could be said for orders received by phone, facsimile or by the mail based on catalog or television-based merchandizing. Such order fulfillment is known as E-commerce and places demands on an order fulfillment system to meet such obligations. This is compounded by the fact that E-commerce usually involves a large number of small orders (each containing as few as one item in the order) that are selected from a large number of potential items. Each unique item has a specific inventory identification, known in the industry as a stock-keeping unit (SKU). Each item usually bears an optical code, such as a barcode or radio frequency identification (RFID) tag that identifies the SKU of the item.

There is a growing need to provide an efficient method for managing warehouses that fulfill orders for obtaining items.

### SUMMARY

There may be provided a storage system, a method and a non-transitory computer readable medium for managing a warehouse having robots of different types.

A method for responding to a managing one or more warehouses, the method may include: obtaining information about multiple tasks completion agents (TCAs) of the one or more warehouses, wherein a TCA may be configured to execute a task related to fulfillments of an order to obtain an item stored in the one or more warehouses, wherein the TCAs may include robots of different types that differ from each other by one or more task related properties; receiving multiple orders to obtain multiple items stored in the one or more warehouses; scheduling an execution of tasks related to the provision of the multiple items; wherein the scheduling may include allocating at least some of the multiple TCAs to execute tasks related to the provision of the multiple items; wherein the allocating may be based, at least in part, on task related properties of the at least some of the multiple TCAs; and controlling the execution of the tasks related to the provision of the multiple items.

The one or more task related properties may include a reach zone of the TCAs.

The one or more task related properties may include a load carrying capacity of the TCAs.

The one or more task related properties may include a progress velocity of the TCAs.

The TCAs may include at least one human TCA.

The TCAs may include one or more drones, one or more ground-propagating robots and one or more static robots.

The TCAs may include one or more autonomous robots, one or more human controlled robots and one or more humans.

The allocating may include allocating a human of to execute a task that may be not-executable by any of the one or more autonomous robots.

The allocating may include allocating a human of to execute a task that may be not-executable by any of the human controlled robots.

The allocating may be also based on spatial relationships between the multiple items and the TCAs.

The at least one TCA of the at least some of the TCAs may be an autonomous robot and wherein the controlling may include sending to the autonomous robot an instruction to complete a task, avoiding from guiding the autonomous robot during a completion of the task and waiting to receive a completion report from the autonomous robot.

The at least one TCA of the at least some of the TCAs may be an non-autonomous robot and wherein the controlling may include sending to the non-autonomous robot an instruction to complete a task, and guiding the non-autonomous robot to complete the task.

The scheduling may include prioritizing orders based on due dates of the orders.

The scheduling may be also based on item accessibility conditions.

The scheduling may be also based on item availability conditions.

The scheduling of the execution of tasks may include minimizing an effort related to the execution of the tasks.

The controlling may include monitoring an execution of the tasks related to the provision of the multiple items.

The scheduling and the controlling may be executed by a centralized computerized system.

The at least one of the scheduling and the controlling may be executed in a de-centralized manner using at least one TCAs.

The controlling may include changing the allocation.

The controlling may include changing the allocation in response to an occurrence of a fault in a TCA.

The scheduling may include optimizing the execution of the tasks related to the provision of the multiple items.

The optimizing may include reducing lost time between tasks assigned to same TCA.

The optimizing may include reducing futile TCA trips.

The multiple tasks may include unloading trucks, depalletizing, storing pallets, moving pallets, storing boxes, moving boxes, picking items, cycle counting, replenishing, packing, shipping, folding and conveying.

The multiple tasks may include at least some out of unloading trucks, depalletizing, storing pallets, moving pallets, storing boxes, moving boxes, picking items, cycle counting, replenishing, packing, shipping, folding and conveying.

The scheduling of the execution of tasks related to the provision of the multiple items may include allocating path route segments within the one or more warehouses to an execution of the multiple tasks.

The multiple items may include different temperature range (TR) related items associated with different TR constraints, and wherein the scheduling may be responsive to the different TR constraints.

The different TR constraints may be related to a time between extraction from a storage till shipment.

The different TR constraints may be related to storage parameters.

There may be at least three different TRs.

The different warehouses of the one or more warehouses may be associated with different TRs.

The a warehouse of the one or more warehouses may be associated with two or more TRs of the different TRs.

The method may include determining storage locations, within the one or more warehouse or incoming items.

The determining of storage locations may be based on locations and types of PCAs.

The determining of storage locations may be based on popularities of the incoming items.

The determining of storage locations may be based on historic orders obtained by the one or more warehouses.

The determining of storage locations may include load balancing that may be based on popularities of the incoming items.

The determining of storage locations may be based on different temperature range (TR) constraints.

The incoming items may be associated with the different TR constraints.

The scheduling may be based, at least in parts, by paths to be traveled during the execution of the tasks.

There may be provided a non-transitory computer readable medium that stores instructions for: obtaining information about multiple tasks completion agents (TCAs) of the one or more warehouses, wherein a TCA may be configured to execute a task related to fulfillments of an order to obtain an item stored in one or more warehouses, wherein the TCAs may include robots of different types that differ from each other by one or more task related properties; receiving multiple orders to obtain multiple items stored in the one or more warehouses; scheduling an execution of tasks related to the provision of the multiple items; wherein the scheduling may include allocating at least some of the multiple TCAs to execute tasks related to the provision of the multiple items; wherein the allocating may be based, at least in part, on task related properties of the at least some of the multiple TCAs; and controlling the execution of the tasks related to the provision of the multiple items.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example of a method;

FIG. 2 is an example of warehouse; and

FIG. 3 is an example of a warehouse.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a controller. The controller can be a processing circuitry, a part of processing circuitry, a virtual machine core, and the like. The processing circuitry may be implemented as a central processing unit (CPU), a graphic processing circuitry (GPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the application may be provided.

Any reference to a warehouse should be applied mutatis mutandis to one or more warehouses.

Management of a Warehouse that Include Heterogenous Robots

The invention relates to methods and systems for solving the problem of automated warehouse end-to-end and to the collaboration between different types of ground or air robot and humans.

Generally speaking, the goods are stored into a warehouse whether it is at the production site or at a distributor facility or the end user. The usual goods are in boxes. The usual way to deliver the goods to a person in an automated warehouse is having a robot take the box from the storage and present it to a person that picks one or several items from the box. Then, the robot brings back the box to storage. This mode of operation is usually through one type of robot and a centralized computing unit that makes the robots travel to their destination. However, this method is very ineffective for various reasons. First of all, various shapes of robots or kind of robots are more targeted to a certain task. Indeed, a robot that travels fast may not be adapted to retrieving boxes from high shelves, or a forklift isn't efficient at travelling the warehouse to do cycle counts. Thus, the present embodiment offers a two-fold solution. First of all, having multiple types of robots highly dedicated to a task, each robot is less polyvalent but very efficient in its area of expertise, the term robot referring to a ground-based vehicle or a flying one. Second, the present embodiment is based either on a centralized or a decentralized paradigm. The present embodiment refers but not limited to, autonomous forklifts, carts, drones, robotic arm, a shuttle system, conveyors, lifters . . . .

There may be provided a method that may include considering the whole possible actions in a logistic warehouse, from unloading trucks to shipping goods. Whether it be, but not limited to, depalletizing, storing pallets, moving pallets, moving boxes, storing boxes, picking, cycle count, replenishment, packing, shipping, folding, conveying . . . . The present system takes in every action needed to be done either, but not limited to, by a third party Warehouse Management System (WMS) or through manual commands from the User Interface (UI). The list of actions includes, but do not limit to, the actions listed above.

There may be provided a method that may include receiving a given a task or multiple tasks and allocating the execution of the tasks to them into the highly specialized robots. The different agents in the warehouse have different capabilities in terms of reaching heights, maximum loads or whatever limitations they have.

There may be provided a method that may include circumventing these limitations through collaboration—for example—one robot will perform a task that enables a second robot to perform a second task that cannot be performed by the first robot.

The method may choose a best available agents to perform the specific task. The task may include or not the collaboration of multiple types of robots e.g. a forklift robot lowers a box for a fast cart to take it somewhere else, or a forklift gets a box out of its shelf for a drone to cycle count what's in the box or to pick through a gripper an item and then the forklifts puts it back. Another example would be a forklift brings a pallet to a depalletizer that separates every box that is on the pallet to carts that could not have carried the whole pallet. Then the different carts will dispatch the boxes in the warehouse.

There may be provided a method that may include optimizing of the multiple paths of every agent in the warehouse. Indeed, most robotic autonomous warehouse works like a Rail Traffic Management or an Air Traffic Management through the reservation of certain section or air space for a limited time. This method is great when everything runs smoothly, and no unforeseen behavior happens. However, a little deviation on the expected timetable and everything is ruined. Moreover, it is always first come first serve, which is great for planning but not optimized.

There may be provided a method that may take into account a due date for every task however, in this due date, an optimization is performed in order for the robots to be as efficient as can be.

There may be provided a method that may take into account the optional presence of human-based agents. This means that the autonomous agents need to recalculate their routes constantly. The method may work in multiple ways or a combination of these ways, but not limited to, the first way is through detection of the human-based agents, the second way is through a transponder like device that gives the position of every nearby objects, the third way is to limit human agents or any non-managed resource to be located outside of the managed robots' area. The third option will enable a central system to manage all activities in that Warehouse and be agnostic to external interfering. The first two operating ways may be combined e.g. an autonomous robot has both visual, laser or any sensors enabling it to perceive its environment and a Secondary Surveillance Radar (SSR) enabling it to know the exact location, path and velocity of every surrounding objects and from those two means, but not limited to, adapt its own path or enter in a conflict with the other object that will be resolved through rules or negotiation on the importance of their current tasks. Indeed, a robot performing a task with a near due date needs to be prioritize on robots performing tasks with far due date, however, has a lesser priority than a robot that has just enough battery to get to the recharging or battery swapping station.

There may be provided a method that may include secondhand detection, meaning that a first robot will detect an obstacle or a human based agent and will broadcast it to every other robot in the warehouse. The other robots will then be able to not even enter in conflict or be in the need of a rerouting.

There may be provided a method that may consider a possibility of a blocked part of the warehouse. Indeed, in case of, but not limited to, inventory, non-functioning robot, spilled goods or whatever reason, a part of the warehouse must be temporarily or permanently disabled.

There may be provided a method that may take these events into account and to also disable every items in this part of the warehouse but also readjust or just close other areas that are rendered unavailable because the access or exit is through the disabled part of the warehouse. For example, if the lifter to a mezzanine is blocked and it is the only way to access it, the whole mezzanine needs to be disabled even if there are working robots there.

There may be provided a method that may include calculating of the minimum effort required for a certain action given the available resources either robots or else. Example being unloading pallets from a truck and depalletize them into a Goods to Person (G2P) warehouse. The method will then break the task into subtask and analyze the availability of a robot to perform the task. If no robot in the warehouse can perform a particular subtask, the system will send a human or a human-based agent. For this particular example, the subtask can be, unload the truck as soon as possible because the truck needs to leave, transport the pallets to the depalletization area, transport the box to the storage in the G2P. If the autonomous robot that unloads trucks is not available for the next two hours but the tasks that it is currently performing have long due dates, it will automatically readjust its task to come and unload the truck. In case this particular warehouse is not equipped with a depalletizing robot then the operator will get a prompt to send a human based agent to perform this action. Subsequently, when the latter finished its task, the G2P robot will take each box and store them into the G2P warehouse.

There may be provided a method that may autonomously maintaining the autonomous robots, these robots perform self-diagnostics such as, but not limited to, Built-In Test Equipment (BITE). The faults resulting from the self-diagnostics can be, but not limited to, low battery, faulty battery cell, camera not responding, one of the calculators down . . . . The robot will then be able to act on this fault and to perform the required action, which can be, but not limited to, restart the computing unit or any calculator, cut and restore the power in any component of the system, travel, if it can, to one of the maintenance area to be repaired or if it cannot move due to safety issues or any other problem, to stay in place, close the area it is in and wait for human-based agent to process it.

There may be provided a warehouse with at least one or several of the following, loading docks, pallet storage, Goods to Person storage, packing stations, picking stations, shipment; the warehouse has one or several types of robots and/or humans and humans-based vehicles; and the robots can be fixed, moving, ground based, air based, of any size or shapes.

The warehouse may include the collaboration between multiple types of specialized autonomous robots and/or humans and/or humans-controlled robots or vehicles.

The warehouse may include a centralized computing unit that distribute the missions, tasks or routes to the robots enabling the robots to collaborate to perform a series of task that only one robot could not perform due to its limitations.

The warehouse may include, unload trucks, depalletize, storing pallets, moving pallets, storing boxes, moving boxes, picking, cycle count, replenishment, packing, replenish, shipping, folding, conveying. These actions are requester automatically through connection with the WMS or manually.

There may be provided a method that may facilitate intelligent collaboration of different kinds of specialized robots especially, but not limited to, the collaboration between a forklift and a cart to be as effective as possible.

There may be provided a method that may apply an optimization of the order of the missions the robots will perform to optimize their path in the warehouse and to avoid lost times between missions or to minimize empty trips.

There may be provided a method that may close of a certain part of the warehouse in case of a technical problem in a robot, preventing it to move or demanded by the operator.

There may be provided a method that may include calculating the minimal required actions to perform a certain task. This calculation will take into account the robots present in the warehouse, the future tasks they need to perform, their due dates etc.

There may be provided a method that may include automatic maintenance of the autonomous robots in case of a faulty BITE or a low battery.

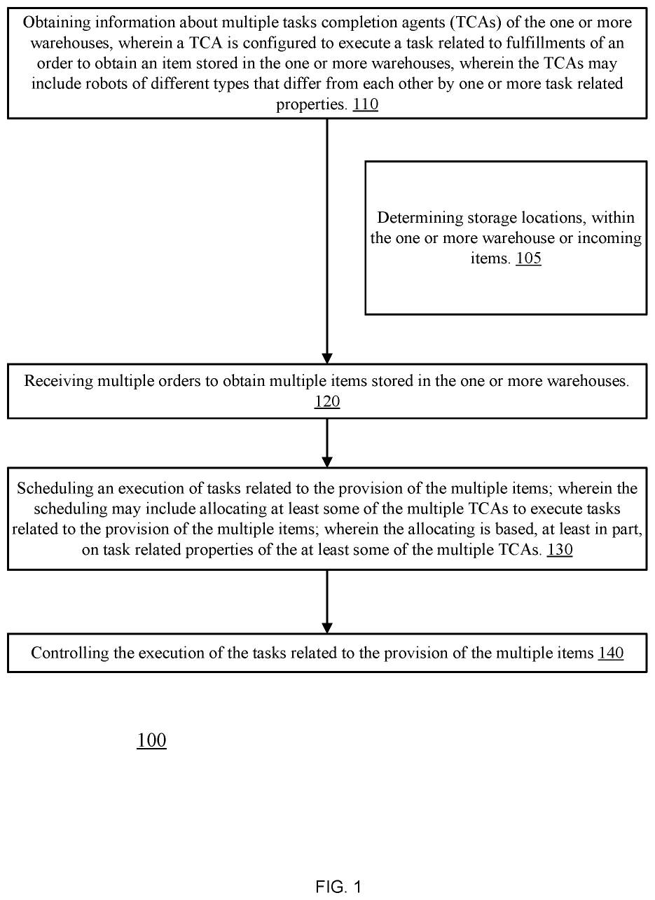

FIG. 1 illustrates an example of method 100 for managing one or more warehouses.

Method 100 may start by step 110 of obtaining information about multiple tasks completion agents (TCAs) of the one or more warehouses, wherein a TCA is configured to execute a task related to fulfillments of an order to obtain an item stored in the one or more warehouses, wherein the TCAs may include robots of different types that differ from each other by one or more task related properties. The obtaining may include receiving, retrieving, generating, and the like.

The one or more task related properties may include at least one out of (a) a reach zone of the TCAs (for example the capability to reach items located at different heights, the capability to travel and reach an item—which may impacted by the width of the TCA, the width of the path to the item, terrain leading to the item, and the like), (b) a load carrying capacity of the TCAs (especially maximal local carrying capability), (c) progress velocity of the TCAs, (d) controllability of the TCA (autonomous TCAs require less control and interactions, may be preferable—especially when there are communication problems and/or lack of communication bandwidth), and the like.

The TCAs may include at least one human TCA.

The TCAs may include one or more drones, one or more ground-propagating robots and one or more static robots.

The TCAs may include one or more autonomous robots, one or more human controlled robots and one or more humans.

Step 110 may be repeated many times—constantly or in a non-continuous manner.

Step 110 may be followed by step 120 of receiving multiple orders to obtain multiple items stored in the one or more warehouses.

Step 120 may be followed by step 130 of scheduling an execution of tasks related to the provision of the multiple items; wherein the scheduling may include allocating at least some of the multiple TCAs to execute tasks related to the provision of the multiple items; wherein the allocating is based, at least in part, on task related properties of the at least some of the multiple TCAs.

The allocating may include at least one out of: (a) allocating a human of to execute a task that is not-executable by any of the one or more autonomous robots, (b) allocating a human of to execute a task that is not-executable by any of the human controlled robots, (c) allocating based on spatial relationships between the multiple items and the TCAs.

At least one TCA of the at least some of the TCAs is an autonomous robot and the controlling may include sending to the autonomous robot an instruction to complete a task, avoiding from guiding the autonomous robot during a completion of the task and waiting to receive a completion report from the autonomous robot.

At least one TCA of the at least some of the TCAs is an non-autonomous robot and the controlling may include sending to the non-autonomous robot an instruction to complete a task, and guiding the non-autonomous robot to complete the task.

The scheduling may include at least one out of: (a) prioritizing orders based on due dates of the orders, (b) scheduling based on item accessibility conditions—for example height of stored item, path to the stored item, (c) minimizing an effort related to the execution of the tasks, (d) changing the allocation, (d) changing the allocation in response to an occurrence of a fault in a TCA, (e) optimizing the execution of the tasks related to the provision of the multiple items.

The optimizing may include at least one out of (a) reducing lost time between tasks assigned to same TCA, or (b) reducing futile TCA trips—or applying any optimization process on one or more aspects of the execution of the multiple tasks.

The multiple tasks may include one, some, a majority of or all the following: unloading trucks, depalletizing, storing pallets, moving pallets, storing boxes, moving boxes, picking items, cycle counting, replenishing, packing, shipping, folding and conveying.

The scheduling may include allocating path route segments within the one or more warehouses to an execution of the multiple tasks.

Step 130 may be followed by step 140 of controlling the execution of the tasks related to the provision of the multiple items.

There may be many repetitions of steps 120, 130 and 140.

The controlling may include at least one out of (a) monitoring an execution of the tasks related to the provision of the multiple items, (b) verifying a completion of the multiple tasks, (c) sending commands and/or requests and/or guidelines.

Any step of 100 may be executed by a centralized computerized system or in a de-centralized manner using at least one TCAs.

The multiple items may include different temperature range (TR) related items associated with different TR constraints, and step 120 may be responsive to the different TR constraints.

Different TR constraints may be related to a time between extraction from a storage till shipment.

The different TR constraints may be related to storage parameters.

There may be at least three different TRs.

Different warehouses of the one or more warehouses are associated with different TRs.

A warehouse of the one or more warehouses may be associated with two or more TRs of the different TRs.

The method may include determining (step 105) storage locations, within the one or more warehouse or incoming items.

The determining of storage locations may be based on at least one out of (a) locations and types of PCAs, (b) popularities of the incoming items, (c) historic orders obtained by the one or more warehouses, (d) load balancing that is based on popularities of the incoming items, (e) different temperature range (TR) constraints.

Step 105 may include, for example:
a. Running (for example by a backend of a system) an optimization on the placement of the boxes based on the type of robots available in the specific warehouse. It scores every box based on the need to fulfil order and on the past demand of the content of the box to place the box in an optimal location.
b. Reviewing, the optimal locations by another algorithm that is linked to the routing to reduce the future load on the roads. Indeed, if the method puts every box with a high score in the same aisle, it will induce traffic jams and thus, to prevent those traffic jams, we place the high score boxes in multiple aisles.
c. Calculating (for example by the backend process) a route of every robots based on its capabilities for example but not limited to, the lift robot won't be sent in a passage that is lower than the minimal height of the robot, the cart robot won't be traveling after a lift robot because the cart robot drives 30% faster than the lift robot.

The tasks scheduled during step 120 may include the task executed during step 105.

There may be provided a non-transitory computer readable medium that stores instructions for: obtaining information about multiple tasks completion agents (TCAs) of the one or more warehouses, wherein a TCA is configured to execute a task related to fulfillments of an order to obtain an item stored in one or more warehouses, wherein the TCAs may include robots of different types that differ from each other by one or more task related properties; receiving multiple orders to obtain multiple items stored in the one or more warehouses; scheduling an execution of tasks related to the provision of the multiple items; wherein the scheduling may include allocating at least some of the multiple TCAs to execute tasks related to the provision of the multiple items; wherein the allocating is based, at least in part, on task related properties of the at least some of the multiple TCAs; and controlling the execution of the tasks related to the provision of the multiple items.

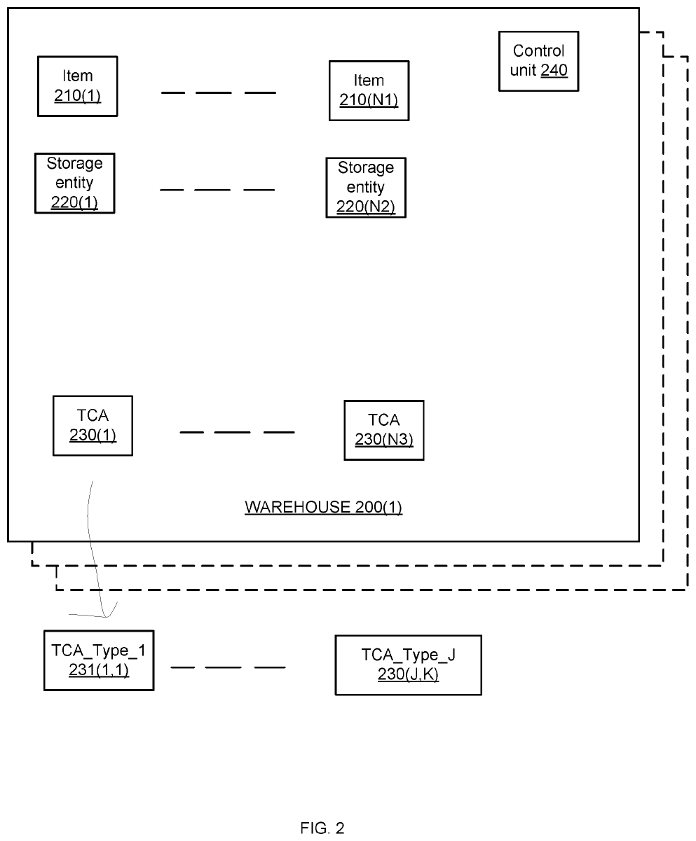

FIG. 2 illustrates a warehouse 200(1), items (210(1) till 210(N1)) stored in the warehouse, storage entities 220(1)-220(N2) (such as boxes, shelves, buffers, temperature controlled storage entities, ambient temperature storage entities and the like), TCAs such as TCA 230(1)-TCA 230(N3). N1, N2 and N3 are integers that exceed one. There may be two or more (J) types of TCAs—and TCA 230(1)-TCA 230(N3) may include one or more TCA per type (see for example TCA_TYPE_1 231(1,1) till TCA_Type_J 231(J,K). There may be more than one TCA (as illustrated by the dashed lines).

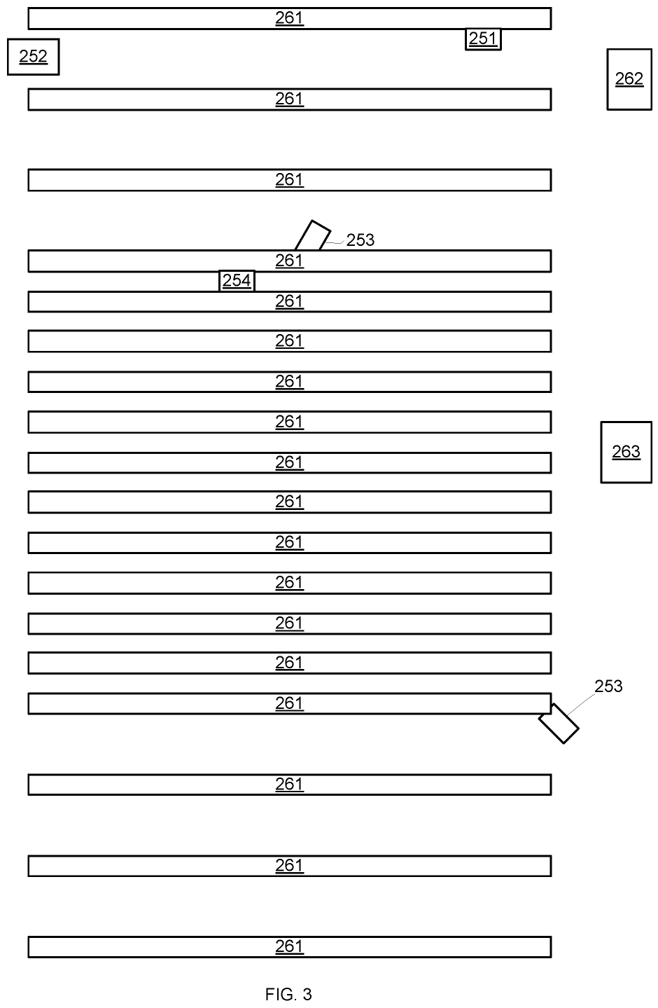

FIG. 3 illustrates an example of different storage entities—such as shelves 261, and stations 262 and 263. FIG. 3 also illustrates various types of TCAs—a static TCA 251, a wide movable TCA 252 that can move between shelves when the lane between the shelves is of a first value—that exceeds the width of most of the paths of FIG. 3, a narrow movable TCA 254 that can move even over narrower paths, and a under-shelf moving TCA 253.

### Different Temperatures

The present embodiment is related to warehouses. In particular, the present embodiment is related to systems for efficiently retrieving goods with different storage temperature from warehouses.

The present embodiment is directed to an order fulfillment method and a system for carrying out such method and, in particular, to such method and system that is useful for processing a large number of orders in a relatively short period of time.

Example systems and techniques may additionally provide for multiple storage temperature. For example, usually when talking about groceries warehouse, three temperatures range items can be found i.e. dry goods at room temperature, refrigerated items, depending on local regulations, usually between 0° C. to 4° C. and frozen items, depending on local regulations, usually lower than −18° C. This invention relates to handling in an automated warehouse these broad ranges of temperature.

In an automated warehouse, is considered an instance every robot, human, drone or anything else that can move, do inventory, identify, cycle count, depalletize, pack or every other action needed in a logistic warehouse. The instances may be, but not limited to, an autonomous robot, an autonomous forklift, an autonomous drone, a shuttle system, conveyors, lifters, a human, a human-piloted robot, a human-piloted forklift, a human piloted drone, different kind of robots. Given that every instance should be able to perform under the different temperature ranges in the specific warehouse.

The different storage temperature items could be either stored in different but connected warehouse where the temperature of the whole warehouse stands on the correct range of temperature. The connection between warehouse could be anything from automatic doors to plastic curtains or virtual pulsed air curtain. Or the items can be stored in the same warehouse and specific shelves are kept at the required temperature e.g. shelves for refrigerated items are placed in refrigerators and shelves for frozen items are placed into freezers. Those refrigerators and freezers either have automatic doors that allow a warehouse instance to put or retrieve a bin from or to a shelving that sits in the refrigerator or freezer, or an open façade such as those found in supermarkets and obviously allows a warehouse instance to put or retrieve a box from or to a shelving that sits in the refrigerator.

The invention relates to methods and systems for solving the problem of automated warehouse part of it or end-to-end with regard to different storage temperature of items in the same warehouse or different but connected warehouses.

Generally speaking, the goods are stored into a warehouse whether it is at the production site or at a distributor facility or the end user. The usual goods are in boxes. The usual way to deliver the goods to a person in an automated warehouse is having a robot take the box from the storage and present it to a person that picks one or several items from the box. Then, the robot brings back the box to storage. This mode of operation is usually dedicated to one storage temperature. When several items with different storage temperatures are needed for the same customer order, usually, the items are located in several warehouses, each one with its own dedicated temperature. This brings an operational challenge of consolidating into one shipment several orders each one from another warehouse.

The present embodiment refers but not limited to, three storage temperatures, being room temperature, refrigerated and frozen.

There may be provided a method that may operate when the storage is divided between three dedicated warehouses that are connected to one another. The connection would be a way for moving instances to travel from one warehouse to the other through, but not limited to, automatic doors, plastic curtains, or pulsed air curtain. Taking the previous example, we could infer three connected warehouses, one at frozen temperature that is connected to a refrigerated warehouse that is itself connected to a room temperature storage where the picking stations stands. This means that when a customer order needs to be fulfilled with the three kind of items in it, the robots will then travel to the frozen storage to bring the frozen items to the picking station for the instance to pick from the box (can be but not limited to human or robot arm) then the refrigerated items are brought to the picking instance then the dry goods. The order of fulfillment is subject to change due to several parameters such as, but not limited to, optimization of the instances' movement, similarity between orders or local regulations on storage temperature of items.

There may be provided a method that may operate with a presence in the same warehouse of standard shelving located in, but not limited to, refrigerators or freezer that accommodate the storage temperature of the stored items. Those refrigerators or freezers would contain the standard shelving and the goods in their standard boxes, they would be either, but not limited to, closed with automatic doors that open and close to let the instances to put or retrieve a box to or from a shelving location or wide open with a pulsed air curtain which effectively will let the instances put or retrieve the boxes to or from the shelving location. Using standard shelving and boxes as used in other areas inside the warehouse, enable the instances moving in the warehouse such as robots, human, drones or any other kind of instances to interface with all boxes and shelves in the same manner. In addition, refrigerators or freezers that covers standard shelving will prevent the need from the moving instances to move between areas with different temperatures and humidity, the moving instances will stay in the same environment temperature everywhere in the warehouse. Frequent movements between temperatures is harmful and can create damages to any kind of instance e.g. robots, drones, forklift or even human been.

There may be provided a method that may take into account the actual time that a box spends travelling outside its area of storage temperature. Indeed, depending on local regulations, for example, the frozen items can spend less than a certain amount of time outside of a frozen area. Then, the system must ensure that the box containing said items are returned to the frozen area before that time is spent.

There may be provided a method that may take into account the several challenges of a robot or any mechanical or electrical devices travelling from or to areas that have very disparate environmental conditions such as, but not limited to, temperature or humidity and thus, either creating a staging area between the different zones that lets the instance adapt to the environmental conditions or letting the instances stay in said areas and having common shelving to pass the boxes to and from said area.

There may be provided a warehouse with at least one or several of the following, Goods to Person storage, picking stations and at least two different storage temperature; the warehouse has one or several types of robots and/or humans and humans-based vehicles; the robots can be fixed, moving, ground based, air based, of any size or shapes.

The warehouse may include several connected warehouses to store the items at several storage temperature or equipment to control the temperature of designated shelving. The idea being regular shelving put in refrigerators or freezers.

There may be provided a method that may apply a way of putting or retrieving to and from said areas or equipment.

There may be provided a method that may apply a control over the actual time the boxes or items travel outside of their temperature-controlled areas.

There may be provided a method that may apply a particular attention to moving equipment such as, but not limited to, robots that travel to and from areas with different environmental conditions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic DSs are merely illustrative and that alternative embodiments may merge logic DSs or circuit elements or impose an alternate decomposition of functionality upon various logic DSs or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

1. A method for managing one or more warehouses, the method comprising
obtaining information about multiple tasks completion agents (TCAs) of the one or more warehouses, wherein each TCA is configured to execute at least a task related to fulfillments of an order to obtain an item stored in the one or more warehouses, wherein the multiple TCAs comprises at least one type of TCAs differing from each other by capabilities with respect to one or more task related properties; wherein each type of TCAs comprises: (i) one or more autonomous robots, (ii) one or more human controlled robots and (iii) one or more humans;
receiving multiple orders to obtain multiple items stored in the one or more warehouses;
scheduling an execution of tasks related to the provision of the multiple items; wherein the scheduling comprises (i) allocating at least some of the multiple TCAs to execute tasks related to the provision of the multiple items; wherein the allocating is based, at least in part, on task related properties of the at least some of the multiple TCAs and on spatial relationships between the multiple items and the TCAs; and (ii) controlling the execution of the tasks related to the provision of the multiple items.

2. The method according to claim 1, wherein the one or more task related properties comprise at least one of: a reach zone of the TCAs, a load carrying capacity of the TCAs or a progress velocity of the TCAs.

3. (canceled)

4. (canceled)

5. (canceled)

6. (canceled)

7. (canceled)

8. The method according to claim 17, wherein the allocating comprises allocating a human to execute a task that is not-executable by any of the one or more autonomous robots or of the human controlled robots.

9. (canceled)

10. (canceled)

11. The method according to claim 1, wherein at least one TCA of the at least some of the TCAs is an autonomous robot, and wherein the controlling of the execution of the tasks comprises sending to the autonomous robot an instruction to complete a task, avoiding from guiding the autonomous robot during a completion of the task and waiting to receive a completion report from the autonomous robot.

12. The method according to claim 1, wherein at least one TCA of the at least some of the TCAs is an non-autonomous robot, and wherein the controlling of the execution of the tasks comprises sending to the non-autonomous robot an instruction to complete a task- and guiding the non-autonomous robot to complete the task.

13. The method according to claim 1, wherein the scheduling of the execution of tasks comprises at least one of (i) prioritizing orders based on due dates of the orders; (ii) minimizing an effort related to the execution of the tasks; (iii) optimizing the execution of the tasks related to the provision of the multiple items or (iv) allocating path route segments within the one or more warehouses to an execution of the tasks.

14. The method according to claim 1, wherein the scheduling of the execution of tasks is based on at least one of (i) item accessibility conditions; (ii) item availability conditions.

15. (canceled)

16. (canceled)

17. The method according to claim 1, wherein the controlling of the execution of the tasks comprises at least one of (i) monitoring an execution of the tasks related to the provision of the multiple items or (ii) changing the allocation.

18. (canceled)

19. (canceled)

20. (canceled)

21. The method according to claim 17, wherein the changing of the allocation is performed in response to an occurrence of a fault in a TCA.

22. (canceled)

23. (canceled)

24. (canceled)

25. (canceled)

26. The method according to claim 1, wherein the tasks related to fulfillments of an order comprise at least one of unloading trucks, depalletizing, storing pallets, moving pallets, storing boxes, moving boxes, picking items, cycle counting, replenishing, packing, shipping, folding or conveying.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A non-transitory computer readable medium that stores instructions that once executed by a computerized system causes the computerized system to manage one or more warehouses, by:
obtaining information about multiple tasks completion agents (TCAs) of the one or more warehouses, wherein a TCA is configured to execute a task related to fulfillments of an order to obtain an item stored in one or more warehouses, wherein the multiple TCAs comprise at least one type of TCAs differing from each other by capabilities with respect to one or more task related properties, wherein each type of TCAs comprises: (i) one or more autonomous robots, (ii) one or more human controlled robots and (iii) one or more humans;
receiving multiple orders to obtain multiple items stored in the one or more warehouses;
scheduling an execution of tasks related to the provision of the multiple items; wherein the scheduling comprises (i) allocating at least some of the multiple TCAs to execute tasks related to the provision of the multiple items; wherein the allocating is based, at least in part, on task related properties of the at least some of the multiple TCAs and on spatial relationships between the multiple items and the TCAs; and (ii) controlling the execution of the tasks related to the provision of the multiple items.

48. The method according to claim 13, wherein the optimizing of the execution of the tasks comprises at least one of (i) reducing lost time between tasks assigned to same TCA; (ii) reducing futile TCA trips.

49. A system for managing one or more warehouses, the system comprising:
multiple tasks completion agents (TCAs), wherein each TCA is configured to execute a task related to fulfillments of an order to obtain an item stored in the one or more warehouses, wherein the multiple TCAs comprises at least one type of TCAs differing from each other by capabilities with respect to one or more task related properties; wherein each type of TCAs comprises: (i) one or more autonomous robots, (ii) one or more human controlled robots and (iii) one or more humans;
a controller being configured and operable to (i) obtain information about said multiple TCAs; (ii) receive multiple orders to obtain multiple items stored in the one or more warehouses; (iii) scheduling an execution of tasks related to the provision of the multiple items; wherein the scheduling comprises (i) allocating at least some of the multiple TCAs to execute tasks related to the provision of the multiple items; wherein the allocating is based, at least in part, on task related properties of the at least some of the multiple TCAs and on spatial relationships between the multiple items and the TCAs; and (ii) controlling the execution of the tasks related to the provision of the multiple items.

50. The system of claim 49, wherein the TCAs comprise robots of different types.

51. The system of claim 49, wherein the TCAs comprise at least one of one or more drones, one or more ground-propagating robots or one or more static robots.

52. The system of claim 49, wherein the one or more task related properties comprise at least one of a reach zone of the TCAs, a load carrying capacity of the TCAs or a progress velocity of the TCAs.

53. The system of claim 49, wherein said controller comprises a centralized computerized system being configured and operable to executing the scheduling and the controlling of the execution of tasks.

54. The system of claim 53, wherein said centralized computerized system is configured and operable to distribute missions, tasks or routes to the TCAs, enabling the TCAs to collaborate and to perform a series of tasks.
